(19) United States
(12) Patent Application Publication
(10) Pub. No.: US 2021/0168022 A1
(43) Pub. Date: Jun. 3, 2021

(54) COMMUNICATION APPARATUS AND COMMUNICATION METHOD

(71) Applicant: NIPPON TELEGRAPH AND TELEPHONE CORPORATION, Tokyo (JP)

(72) Inventors: Takamitsu TOCHINO, Musashino-shi, Tokyo (JP); Takashi MITSUI, Musashino-shi, Tokyo (JP); Tomoya HATANO, Musashino-shi, Tokyo (JP)

(73) Assignee: NIPPON TELEGRAPH AND TELEPHONE CORPORATION, Tokyo (JP)

(21) Appl. No.: 17/258,589

(22) PCT Filed: Jun. 25, 2019
(86) PCT No.: PCT/JP2019/025086

§ 371 Date: Jan. 7, 2021

(30) Foreign Application Priority Data
Jul. 11, 2018 (JP) 2018-131516

(51) Int. Cl. H04L 12/24; H04J 14/08; H04L 12/801

(52) U.S. Cl. CPC H04L 41/0654; H04L 47/12; H04J 14/08

(57) ABSTRACT

A first communication device in an optical access system in which the first communication device and a plurality of second communication devices communicate through a time division multiple access scheme includes: an Ethernet (registered trademark) controller configured to implement a communication as an Ethernet communication; a link failure detection unit configured to detect, when the plurality of second communication devices perform an initial connection to a network in the optical access system, whether a link failure has occurred based on collision detection of an optical signal transmitted by each of the plurality of second communication devices; and a signal processing unit configured to output, when the link failure detection unit detects that the link failure has not occurred, an initial connection start notification for causing initiation of a processing of the initial connection.

### TECHNICAL FIELD

The present disclosure relates to a communication device and a communication method.

### BACKGROUND ART

Ethernet (registered trademark) is a wired network protocol used worldwide, and is adopted in many standard network devices.

Especially, Ethernet (registered trademark) with its physical layer defined by an optical interface employing an optical transmission technique has been used exclusively for Point-to-Point (P2P) communications, and has been widespread as an interface enabling long-range high-speed communications.

When the above P2P network topology is used in an access network that accommodates a plurality of network devices, especially for performing long-distance transmission in particular, a high installation cost of the optical fiber and a large occupation area of station devices are required. In view of this issue, a Point-to-Multipoint (P2MP) communication system using a Passive Optical Network (PON) topology has been used as a PON system for an access network. In the PON system, an optical fiber and an optical line terminal (OLT) are shared among a plurality of optical network units (ONUs) so that the installation cost of the optical fiber and the occupation area of the OLT can be reduced. This configuration of the PON system has been defined by the Institute of Electrical and Electronics Engineers (IEEE).

In known PON systems, a Discovery process is executed for establishing initial connection between the OLT and the ONU. The Discovery process is a method in which an OLT newly registers an ONU. The initial connection between the OLT and the ONU is performed on the basis of this registration (see Non Patent Literature 1).

FIG. 9 is a diagram illustrating a network configuration in which an ONU is newly connected to a PON system. As illustrated in FIG. 9, the OLT is already connected to at least one connected ONU (hereinafter referred to as “connected ONU”). At least one ONU yet to be connected (hereinafter referred to as “unconnected ONU”) establishes an initial connection with the OLT through the Discovery process.

FIG. 10 is a block diagram illustrating a configuration of a communication system in which the Discovery process is executed according to a known technique. FIG. 11 is a sequence diagram illustrating a flow of processing for the Discovery process according to the known technique. FIG. 12 is a flowchart illustrating a flow of processing for the Discovery process according to the known technique. The flow of the processing for the Discovery process according to the known technique will be described with reference to FIGS. 10 to 12.

The Discovery process is executed with none of the connected ONUs transmitting data. When the Discovery process starts, a message processing unit of the OLT transmits a Discovery_Gate signal to all the ONUs via a data signal transmission processing unit, a data signal transmission unit, and a data signal optical transmission unit.

A message processing unit of the unconnected ONU receives the Discovery_Gate signal via a data signal optical reception unit, a data signal reception unit, and a data signal reception processing unit.

Upon receiving the Discovery_Gate signal, the message processing unit of the unconnected ONU transmits a Register_Request signal to the OLT via a data signal transmission processing unit, a data signal transmission unit, and a data signal optical transmission unit. This process is implemented through burst transmission of an optical signal to the OLT via an optical signal control instruction unit, an optical signal output control unit, and an optical signal control unit of the unconnected ONU.

The message processing unit of the OLT receives the Register_Request signal via a data signal optical reception unit, a data signal reception unit, and a data signal reception processing unit. Upon receiving the Register_Request signal, the message processing unit of the OLT recognizes an identifier described in the Discovery_Gate signal. The message processing unit of the OLT transmits a Register signal to the unconnected ONU via the data signal transmission processing unit, the data signal transmission unit, and the data signal optical transmission unit.

The message processing unit of the unconnected ONU receives the Register signal via the data signal optical reception unit, the data signal reception unit, and the data signal reception processing unit. Upon receiving the Register signal, the message processing unit of the unconnected ONU transmits a Register_ACK signal to the OLT via the data signal transmission processing unit, the data signal transmission unit, and the data signal optical transmission unit.

The message processing unit of the OLT receives the Register_ACK signal via the data signal optical reception unit, the data signal reception unit, and the data signal reception processing unit.

Through the processing described above, the Discovery process is completed, whereby the initial connection is completed with the unconnected ONU registered in the OLT.

### CITATION LIST

### Non Patent Literature

Non Patent Literature 1: “IEEE Standard for Ethernet SECTION FIVE”, IEEE Std 802.3TM-2015″, IEEE Computer Society, pp. 310-343, 675-709, 2015 Non Patent Literature 2: “IEEE Standard for Ethernet SECTION FOUR”, IEEE Std 802.3TM-2015”, IEEE Computer Society, pp. 321-323, 2015

### SUMMARY OF THE INVENTION

### Technical Problem

In a known technique, a type of Ethernet (registered trademark) with a physical layer defined by an optical interface is used for Point-to-Point (P2P) type long-range high-speed communications or the like. Use of the P2P network topology in an access network involves a risk of an increase in the optical fiber installation cost. Thus, a PON system using the PON topology for P2MP has been used for access networks.

In the PON system, the Discovery process is executed for establishing the initial connection between the OLT and the ONU. When the PON system is implemented using an Ethernet (registered trademark) device that is a general-purpose device, an ONU using a 10 G Ethernet (registered trademark) device in particular transmits an optical signal before being controlled by the OLT. Thus, the optical signal transmitted by the ONU collides with the optical signal transmitted by another ONU. This results in a failure to establish the initial connection. Furthermore, due to the limitation imposed by a link failure notification function that is a required standard of 10 G Ethernet (registered trademark), the Discovery process cannot be executed in a state where the optical signals have not been transmitted from all the connected ONUs yet. All things considered, there is a problem in that the initial connection cannot be established with the known technique or similar.

The present disclosure has been made in view of the above, and an object of some aspects of the present disclosure is to provide a technique enabling the initial connection to be established with standard Ethernet (registered trademark) devices alone, in a configuration in which a plurality of network devices are connected to each other by the PON topology.

### Means for Solving the Problem

One aspect of the present disclosure is a communication device including a first communication device and a plurality of second communication devices in an optical access system in which the first communication device and the plurality of second communication devices communicate through a time division multiple access scheme, the first communication device including: an Ethernet (registered trademark) controller configured to implement a communication as an Ethernet communication; a link failure detection unit configured to detect, when the plurality of second communication devices perform an initial connection to a network in the optical access system, whether a link failure has occurred based on collision detection of an optical signal transmitted by each of the plurality of second communication devices; and a signal processing unit configured to output, when the link failure detection unit detects that the link failure has not occurred, an initial connection start notification for causing initiation of a processing of the initial connection.

One aspect of the present disclosure is a communication device including a first communication device and a plurality of second communication devices in an optical access system in which the first communication device and the plurality of second communication devices communicate through a time division multiple access scheme, the second communication device including: an Ethernet (registered trademark) controller configured to implement a communication as an Ethernet communication; and a first suspension instruction unit configured to output, when the plurality of second communication devices perform an initial connection to a network in the optical access system, a first suspension instruction for causing suspension of an output of an optical signal to the first communication device for a predetermined time period.

One aspect of the present disclosure is the communication device described above, further including a first transmission instruction unit configured to output, when an initial connection start notification for causing initiation of a processing of the initial connection transmitted by the first communication device is not received over the predetermined time period after connected to the network, a first transmission instruction for causing transmission of an idle signal to the first communication device.

One aspect of the present disclosure is the communication device described above, further including a retransmission instruction unit configured to output, when a link failure occurrence notification indicating an occurrence of a link failure that is transmitted by the first communication device in response to the transmission of the idle signal to the first communication device is received, a retransmission instruction for causing suspension of an output of the optical signal to the first communication device and retransmit the idle signal after an optional time period elapses.

One aspect of the present disclosure is the communication device described above, further including a second suspension instruction unit configured to output, when a link failure occurrence notification indicating occurrence of a link failure is received after an initial connection start notification for causing initiation of a processing of the initial connection is received while the communication device has been connected to the network, a second suspension instruction for causing suspension of an output of the optical signal to the first communication device.

One aspect of the present disclosure is the communication device described above, further including a second transmission instruction unit configured to, when a link failure occurrence notification indicating an occurrence of a link failure is received while the communication device has been connected to the network, transmit a second transmission instruction for causing suspension of an output of the optical signal to the first communication device, and, when the link failure occurrence notification is received while the communication device has not been connected to the network, transmit after elapse of an optional time period an initial connection response to the first communication device that is a response to the first communication device for an initial connection start notification for causing initiation of a processing of the initial connection.

One aspect of the present disclosure is a communication method in an optical access system in which a first communication device and a plurality of second communication devices communicate through a time division multiple access scheme, the communication method performed by a computer of the first communication devices and including: implementing a communications as an Ethernet (registered trademark) communication; detecting, when the plurality of second communication devices perform an initial connection to a network in the optical access system, whether a link failure has occurred based on collision detection of an optical signal transmitted by each of the plurality of second communication devices; and outputting, when it is detected that the link failure has not occurred, an initial connection start notification for causing initiation of a processing of the initial connection.

One aspect of the present disclosure is a communication method in an optical access system in which a first communication device and a plurality of second communication devices communicate through a time division multiple access method, the communication method performed by a computer of the plurality of second communication devices and including: implementing a communication as an Ethernet (registered trademark) communication; and outputting, when the plurality of second communication devices perform an initial connection to a network in the optical access system, a suspension instruction for causing suspension of an output of an optical signal to the first communication device for a predetermined time period.

### Effects of the Invention

Some aspects of the present disclosure enables the initial connection to be performed with standard Ethernet (registered trademark) devices alone, in a configuration in which a plurality of network devices are connected to each other by the PON topology.

### BRIEF DESCRIPTION OF DRAWINGS

FIG. 1 is a diagram illustrating a functional configuration of a communication system 1 according to an embodiment of the present disclosure.

FIG. 2 is a diagram illustrating a flow of the process of connecting the first device in the Discovery process by the communication system 1 according to an embodiment of the present disclosure.

FIG. 3 is a diagram illustrating a flow of the process of simultaneously connecting the first ONU and the second ONU or more in the Discovery process by the communication system 1 according to an embodiment of the present disclosure.

FIG. 4 is a diagram illustrating a flow of the process of connecting one new ONU in a state where at least one ONU is connected, in the Discovery process by the communication system 1 according to an embodiment of the present disclosure.

FIG. 5 is a diagram illustrating a flow of the process of connecting two new ONUs in a state where at least one ONU is connected, in the Discovery process by the communication system 1 according to an embodiment of the present disclosure.

FIG. 6 is a flowchart illustrating a flow of processing in the Discovery process by the communication system 1.

FIG. 7 is a flowchart illustrating a flow of processing in the Discovery process by the communication system 1.

FIG. 8 is a flowchart illustrating a flow of processing in the Discovery process by the communication system 1.

FIG. 9 is a diagram illustrating a network configuration in which an ONU is newly connected to a PON system.

FIG. 10 is a block diagram illustrating a configuration of a communication system in which the Discovery process is executed according to a known technique.

FIG. 11 is a sequence diagram illustrating a flow of processing for the Discovery process according to the known technique.

FIG. 12 is a flowchart illustrating a flow of processing for the Discovery process according to the known technique.

### DESCRIPTION OF EMBODIMENTS

### Embodiments

Hereinafter, an embodiment of the present disclosure will be described with reference to the drawings.

Functional Configuration of Communication System

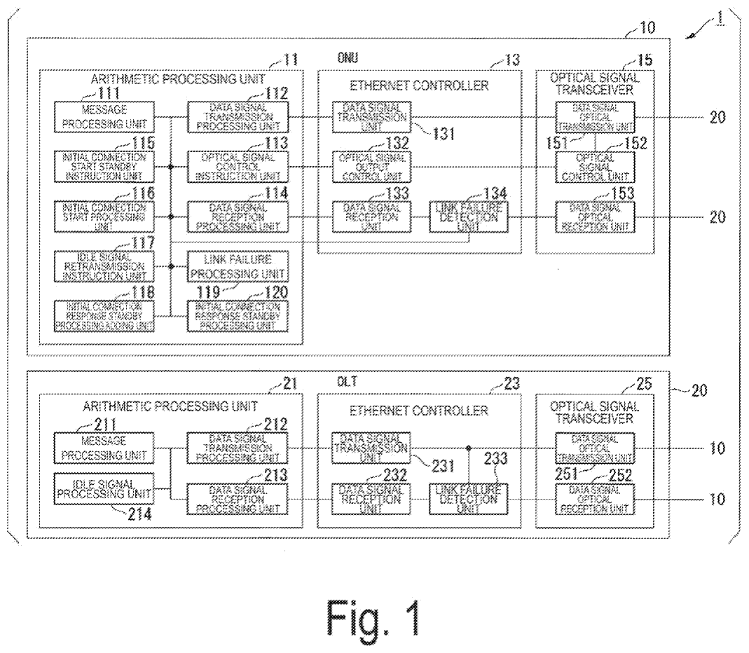

FIG. 1 is a diagram illustrating a functional configuration of a communication system 1 according to an embodiment of the present disclosure. As illustrated in FIG. 1, the communication system 1 is configured to include an ONU 10 and an OLT 20. The communication system 1 is an optical access system in which the OLT 20 (first communication device) and a plurality of the ONUs 10 (second communication devices) communicate under a time division multiple access scheme.

The ONU 10 is configured to include an arithmetic processing unit 11, an Ethernet controller 13, and an optical signal transceiver 15.

The arithmetic processing unit 11 is configured to include a processor such as a Central Processing Unit (CPU), for example. As illustrated in FIG. 1, the arithmetic processing unit 11 includes a message processing unit 111, a data signal transmission processing unit 112, an optical signal control instruction unit 113, a data signal reception processing unit 114, an initial connection start standby instruction unit 115, an initial connection start processing unit 116, an idle signal retransmission instruction unit 117, an initial connection response standby processing adding unit 118, a link failure processing unit 119, and an initial connection response standby processing unit 120.

Note that the message processing unit 111, the data signal transmission processing unit 112, the optical signal control instruction unit 113, the data signal reception processing unit 114, the initial connection start standby instruction unit 115, the initial connection start processing unit 116, the idle signal retransmission instruction unit 117, the initial connection response standby processing adding unit 118, the link failure processing unit 119, and the initial connection response standby processing unit 120 are software programs executed by a processor such as a CPU.

The message processing unit 111 outputs a control start instruction and a control end instruction to each of the data signal transmission processing unit 112 and the optical signal control instruction unit 113.

When the control start instruction is input, the data signal transmission processing unit 112 starts transmission processing on data sent from a request source and in transmission standby (hereinafter referred to as “transmission standby data”). Note that the transmission standby data is stored in a temporary storage medium (not illustrated) provided by the arithmetic processing unit 11 or another functional block of the ONU 10. The data signal transmission processing unit 112 outputs a data signal transmission instruction for causing the transmission of the data signal as well as data on which transmission processing has been executed, to a data signal optical transmission unit 151 of the optical signal transceiver 15 via a data signal transmission unit 131 of the Ethernet controller 13.

When the control start instruction is input, the optical signal control instruction unit 113 outputs an optical signal control instruction for causing optical signal output control, to an optical signal output control unit 132 of the Ethernet controller 13.

The data signal reception processing unit 114 acquires a data signal based on the optical signal received by a data signal optical reception unit 153, from a data signal reception unit 133 via a link failure detection unit 134.
The initial connection start standby instruction unit 115 outputs an instruction to the optical signal control instruction unit 113 to prevent the output of the optical signal for a predetermined time period when network connection is established.

When no initial connection start notification message is received over a predetermined time period after the network connection has been established, the initial connection start processing unit 116 outputs an instruction to the optical signal control instruction unit 113 for causing output of an idle signal.

The idle signal retransmission instruction unit 117 suspends output of the optical signal when a link failure notification is received in response to the transmission of the idle signal. Then, when a random (appropriate) time period elapses, the idle signal retransmission instruction unit 117 outputs an instruction for causing re-output of the idle signal to the optical signal control instruction unit 113.

When the initial connection start notification message is received before the idle signal is re-output, the initial connection response standby processing adding unit 118 outputs an instruction for causing transmission of an initial connection response message to the data signal transmission processing unit 112 after waiting again for the random (appropriate) time period to elapse.

When the link failure notification is received after the reception of the initial connection start notification message with the network connection already established, the link failure processing unit 119 outputs an instruction for suspending output of the optical signal, to the optical signal control instruction unit 113.

The initial connection response standby processing unit 120 suspends the optical signal output when a link failure notification is received in response to the transmission of the idle signal. Then, after a random (appropriate) time period has elapsed, the initial connection response standby processing unit 120 outputs an instruction for causing transmission of an initial connection response message, to the data signal transmission processing unit 112.

The Ethernet controller 13 is a circuit implementing the communications as Ethernet (registered trademark) communications in particular, among circuits that enable data communications under Media Access Control (MAC) and physical (PHY) layer protocols and are installed in a network interface and a network device, for example. As illustrated in FIG. 1, the Ethernet controller 13 is configured to include the data signal transmission unit 131, the optical signal output control unit 132, the data signal reception unit 133, and the link failure detection unit 134.

The data signal transmission unit 131 outputs an electrical signal based on the data signal input from the data signal transmission processing unit 112, to the data signal optical transmission unit 151. Here, the optical signal output control unit 132 controls an optical signal control unit 152 on the basis of an electrical signal output from the data signal transmission unit 131 to the data signal optical transmission unit 151, to control the output of the optical signal transmitted from the data signal optical transmission unit 151.

The data signal reception unit 133 acquires an electrical signal based on the optical signal received by the data signal optical reception unit 153 from the link failure detection unit 134, and outputs a data signal based on the acquired electrical signal to the data signal reception processing unit 114.

The link failure detection unit 134 acquires an electrical signal based on the optical signal received by the data signal optical reception unit 153, and detects the presence or absence of a link failure notification. The link failure detection unit 134 outputs the acquired link failure notification to the link failure processing unit 119.

The link failure detection unit 134 outputs a data signal based on the acquired electrical signal to the data signal reception unit 133.

The optical signal transceiver 15 is a device having a physical medium dependent unit function that can output an electrical signal as an optical signal. Specifically, the optical signal transceiver 15 is an optical module such as, for example, a Small Form-factor Pluggable (SFP) (Mini-GBIC)/SFP+, or an optical module mounted on a printed circuit board. As illustrated in FIG. 1, the optical signal transceiver 15 is configured to include the data signal optical transmission unit 151, the optical signal control unit 152, and the data signal optical reception unit 153.

Under the control by the optical signal control unit 152, the data signal optical transmission unit 151 transmits an optical signal based on the electrical signal input from the data signal transmission unit 131, to the OLT 20 via the network.

Under the control by the optical signal output control unit 132, the optical signal control unit 152 switches ON/OFF an optical pulse on the basis of the values (0 and 1) of the electrical signal input to the data signal optical transmission unit 151. Thus, an optical signal is transmitted to the OLT 20. With the configuration described above, the ONU 10 can transmit the data signal to the OLT 20 as an optical burst signal without using an optical line termination device.
The data signal optical reception unit 153 receives the optical signal transmitted from the OLT 20. The data signal optical reception unit 153 outputs an electrical signal based on the received optical signal, to the link failure detection unit 134.

The OLT 20 is configured to include an arithmetic processing unit 21, an Ethernet controller 23, and an optical signal transceiver 25.

The arithmetic processing unit 21 is configured to include a processor such as a CPU, for example. As illustrated in FIG. 1, the arithmetic processing unit 21 is configured to include a message processing unit 211, a data signal transmission processing unit 212, a data signal reception processing unit 213, and an idle signal processing unit 214.

The message processing unit 211 outputs a control start instruction and a control end instruction to the data signal transmission processing unit 212 and the data signal reception processing unit 213.

When the control start instruction is input, the data signal transmission processing unit 212 starts transmission processing on the transmission standby data. Note that the transmission standby data is stored in a temporary storage medium (not illustrated) provided by the arithmetic processing unit 21 or another functional block of the OLT 20. The data signal transmission processing unit 212 outputs a data signal transmission instruction for causing the transmission of the data signal as well as data on which transmission processing has been executed, to the data signal optical transmission unit 251 of the optical signal transceiver 25 via the data signal transmission unit 231 of the Ethernet controller 23.

The data signal reception processing unit 213 acquires a data signal based on the optical signal received by the data signal optical reception unit 252, from the data signal reception unit 233 via a link failure detection unit 232.

For the initial connection, the idle signal processing unit 214 receives the idle signal, and outputs an instruction for transmitting the initial connection start notification message, to the data signal transmission processing unit 212 in a state with no link failure.

The Ethernet controller 23 is a circuit implementing the communications as Ethernet (registered trademark) communications in particular, among circuits that enable data communications under MAC and physical (PHY) layer protocols, and are installed in a network interface and a network device, for example. As illustrated in FIG. 1, the Ethernet controller 23 is configured to include the data signal transmission unit 231, the data signal reception unit 232, and the link failure detection unit 233.

The data signal transmission unit 231 outputs an electrical signal based on the data signal input from the data signal transmission processing unit 212, to the data signal optical transmission unit 251.

The data signal reception unit 232 acquires an electrical signal based on the optical signal received by the data signal optical reception unit 252 from the link failure detection unit 233, and outputs a data signal based on the received electrical signal to the data signal reception processing unit 213.
The link failure detection unit 233 acquires an electrical signal based on the optical signal received by the data signal optical reception unit 252, and detects the presence or absence of link failures. The link failure detection unit 233 outputs the acquired electrical signal to the data signal reception unit 232.

The optical signal transceiver 25 is a device having a physical medium dependent unit function that can output an electrical signal as an optical signal. Specifically, the optical signal transceiver 25 is an optical module such as, for example, an SFP/SFP+, or an optical module mounted on a printed circuit board. As illustrated in FIG. 1, the optical signal transceiver 25 is configured to include the data signal optical transmission unit 251 and the data signal optical reception unit 252.

The data signal optical transmission unit 251 transmits an optical signal based on the electrical signal input from the data signal transmission unit 231, to the ONU 10 via the network. The data signal optical reception unit 252 receives the optical signal transmitted from the OLT 10. The data signal optical reception unit 252 outputs an electrical signal based on the received optical signal, to the link failure detection unit 233.

With the configuration described above, the initial connection is established.

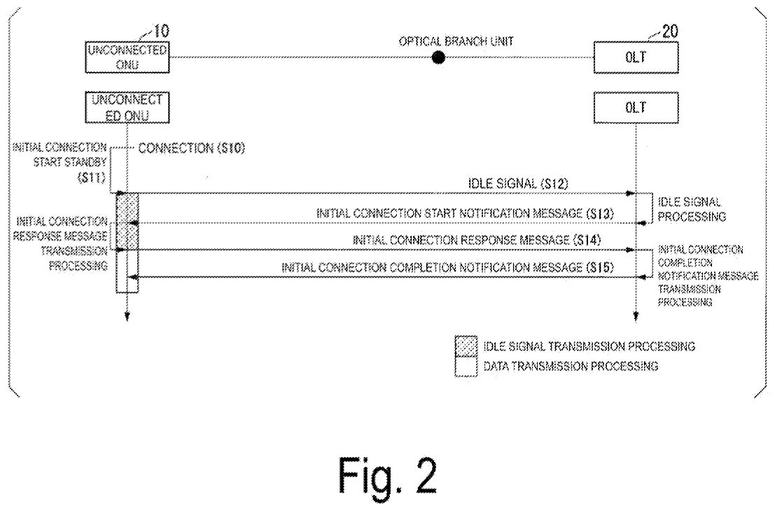

Now, with reference to FIGS. 2 to 8, processes in the Discovery process by the communication system 1 will be described including: a process of connecting the first ONU; a process of simultaneously connecting the first ONU and the second ONU or more; a process of connecting one new ONU in a state where at least one ONU is connected; and a process of connecting two new ONUs in a state where at least one ONU is connected.

Process of connecting first ONU

FIG. 2 is a diagram illustrating the flow of the process of connecting the first device in the Discovery process by the communication system 1 according to an embodiment of the present disclosure.

The unconnected ONU 10 to be connected to the network as the first ONU is connected to the network (step S10), and then enters initial connection start standby without outputting the optical signal due to the instruction from the initial connection start standby instruction unit 115 (S11).

When no initial connection start notification message is received for a predetermined time period, the unconnected ONU 10 transmits the idle signal due to the instruction from the initial connection start standby instruction unit 115 (step S12).
Upon receiving the idle signal, the OLT 20 transmits the initial connection start notification message in response to an instruction from the idle signal processing unit 214 (step S13).

Upon receiving the initial connection start notification message, the unconnected ONU 10 transmits the initial connection response message due to the instruction from the message processing unit 111 (step S14).

Upon receiving the initial connection response message, the OLT 20 transmits an initial connection completion notification message due to the instruction from the message processing unit 211 (step S15).
When the unconnected ONU 10 receives the initial connection completion notification message, the initial connection is completed.

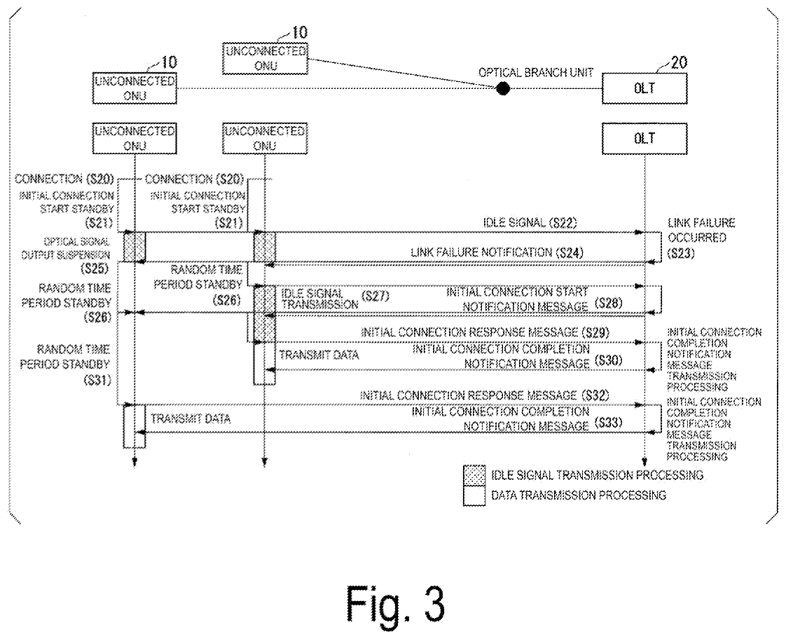

Process of simultaneously connecting first ONU and second ONU or more FIG. 3 is a diagram illustrating the flow of the process of simultaneously connecting the first ONU and the second ONU or more in the Discovery process by the communication system 1 according to an embodiment of the present disclosure.

The unconnected ONUs 10 to establish the initial connection with the network as the first ONU and the second ONU or more are connected to the network (step S20), and then enter the initial connection start standby without outputting the optical signal due to the instruction from the initial connection start standby instruction unit 115 (S21).

When no initial connection start notification message is received for a predetermined time period, the unconnected ONUs 10 transmit the idle signal to the OLT 20 due to the instruction from the initial connection start standby instruction unit 115 (step S22).
The reception of the idle signals transmitted from the two unconnected ONUs 10 by the OLT 10 is a collision event. Thus, the link failure detection unit 233 of the OLT 20 detects a link failure (step S23).

Then, the data signal optical transmission unit 251 of the OLT 20 transmits the link failure notification to the unconnected ONUs 10 (step S24).

Upon receiving the link failure notification, the unconnected ONUs 10 recognizes that the link failure has occurred due to the transmission of the idle signals and thus suspend output of the optical signals (step S25).
After a random (appropriate) time period corresponding to a device unique value has elapsed (step S26), the unconnected ONUs 10 retransmit the idle signal to the PLT 20 due to the instruction from the idle signal retransmission instruction unit 117 (step S27).

Upon receiving the idle signal from the first unconnected ONU 10, the OLT 20 transmits the initial connection start notification message to the unconnected ONU 10 in response to an instruction from the idle signal processing unit 214 (step S28).

Upon receiving the initial connection start notification message, the unconnected ONU 10 transmits the initial connection response message to the OLT 20 due to the instruction from the message processing unit 111 (step S29).
Upon receiving the initial connection response message, the OLT 20 transmits an initial connection completion notification message to the unconnected ONU 10 due to the instruction from the message processing unit 211 (step S30).
When the unconnected ONU 10 receives the initial connection completion notification message, the initial connection is completed.

On the other hand, the unconnected ONU 10 that has received the initial connection start notification message before transmitting the idle signal waits again until the random (appropriate) time period corresponding to the device unique value elapses (step S31), and then transmits the initial connection response message to the OLT 20 due to the instruction from the initial connection response standby processing adding unit 118 (step S32).

Upon receiving the initial connection response message, the OLT 20 transmits an initial connection completion notification message to the unconnected ONU 10 due to the instruction from the message processing unit 211 (step S33).
When the unconnected ONU 10 receives the initial connection completion notification message, the initial connection is completed.

It is possible to keep establishing the initial connection for the third unconnected ONU 10 and after to be connected, by repeating the process described above.

The process ends when the initial connection is completed for all the unconnected ONUs 10.

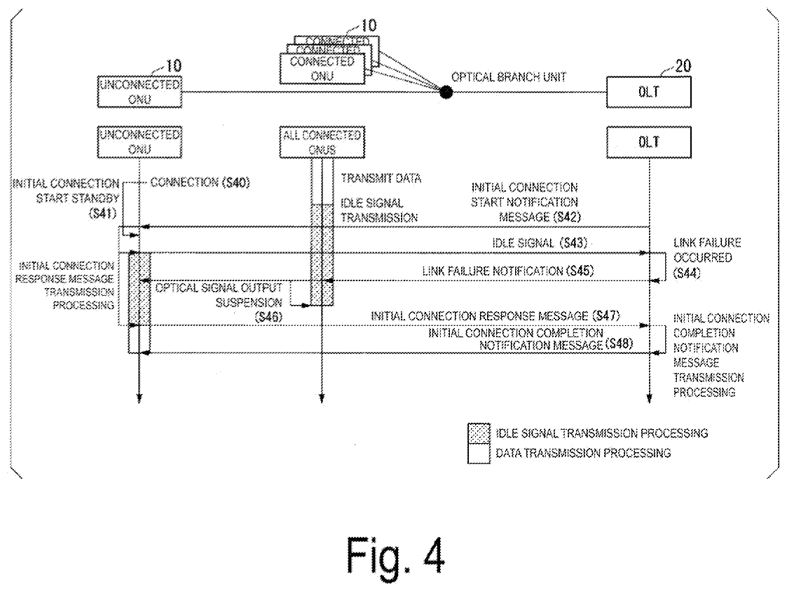

Process of newly connecting one ONU in state where at least one ONU is connected FIG. 4 is a diagram illustrating the flow of the process of connecting one new ONU in a state where at least one ONU is connected, in the Discovery process by the communication system 1 according to an embodiment of the present disclosure.

The unconnected ONU 10 to be newly connected to the network is connected to the network (step S40), and then enters initial connection start standby without outputting the optical signal due to the instruction from the initial connection start standby instruction unit 115 (S41).

Upon receiving the initial connection start notification message transmitted due to the instruction from the message processing unit 211 of the OLT 20 within a predetermined time period (step S42), the unconnected ONU 10 starts transmitting the idle signal to the OLT 20 due to the instruction from the initial connection start standby instruction unit 115 (step S43).
The link failure detection unit 233 of the OLT 20 that has received the idle signal detects the link failure (step S44).

Then, the data signal optical transmission unit 251 of the OLT 20 transmits the link failure notification to the at least one connected ONU 10 and the unconnected ONU 10 (step S45).

Upon receiving the link failure notification, all of the at least one connected ONU 10 suspend output of the optical signal due to the instruction from the link failure processing unit 119 (step S46).
When the optical signal output thus suspends, the unconnected ONU 10 transmits the initial connection response message to the OLT 20 as a response to the initial connection start message, due to the instruction from the message processing unit 111 (step S47).

Upon receiving the initial connection response message, the OLT 20 transmits an initial connection completion notification message to the unconnected ONU 10 due to the instruction from the message processing unit 211 (step S48).

When the unconnected ONU 10 receives the initial connection completion notification message, the initial connection is completed.

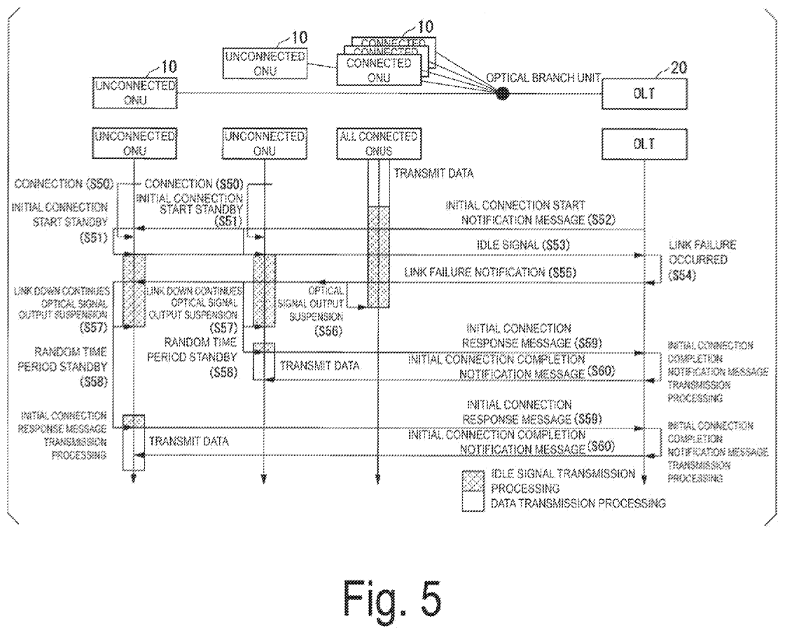

Process of newly connecting two ONU in state where at least one ONU is connected FIG. 5 is a diagram illustrating the flow of the process of connecting two new ONUs in a state where at least one ONU is connected, in the Discovery process by the communication system 1 according to an embodiment of the present disclosure.

The unconnected ONUs 10 to simultaneously establish the initial connection with the network as the first ONU and the second ONU or more to be newly connected to the network are connected to the network (step S50), and then enter the initial connection start standby without outputting the optical signal due to the instruction from the initial connection start standby instruction unit 115 (S51).

Upon receiving the initial connection start notification message transmitted due to the instruction from the message processing unit 211 of the OLT 20 within a predetermined time period (step S52), the unconnected ONU 10 starts transmitting the idle signal to the OLT 20 due to the instruction from the initial connection start standby instruction unit 115 (step S53).

The link failure detection unit 233 of the OLT 20 that has received the idle signal detects the link failure (step S54).

Then, the data signal optical transmission unit 251 of the OLT 20 transmits the link failure notification to all of the at least one connected ONU 10 and all of the two or more unconnected ONUs 10 (step S55).
Upon receiving the link failure notification, the connected ONUs 10 suspend output of the optical signal due to the instruction from the link failure processing unit 119 (step S56).

Still, transmission of the idle signals from two or more unconnected ONUs 10 continues, and thus the link failure continues to occur. If the link failure continues to occur for a predetermined time period, all of the two or more unconnected ONUs 10 suspend transmission of the optical signal to the OLT 20 due to the instruction from the initial connection response standby processing adding unit 118 (step S57).

The unconnected ONUs 10 transmit the idle signal when the respective random (appropriate) time periods elapse (step S58), and then transmits the initial connection response message to the OLT 20 due to the instruction from the message processing unit 111 (step S59).

Upon receiving the initial connection response message, the OLT 20 transmits an initial connection completion notification message to the unconnected ONU 10 that has transmitted the initial connection response message, due to the instruction from the message processing unit 211 (step S60).

When the unconnected ONU 10 receives the initial connection completion notification message, the initial connection is completed.
This flow is repeated until the initial connection is completed for all the unconnected ONUs 20.

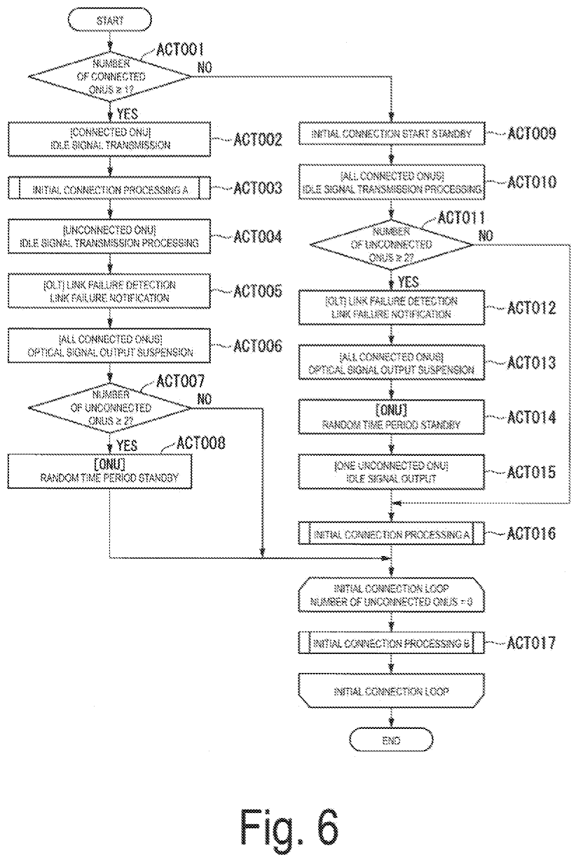

FIG. 6 is a flowchart illustrating a flow of processing in the Discovery process by the communication system 1.

If there is at least one connected ONU 10 (Yes in ACT001), the connected ONU 10 transmits the idle signal to the OLT 20 (ACT002).

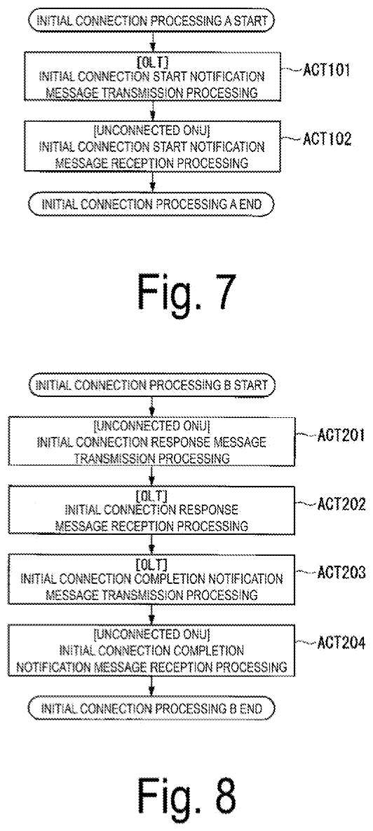

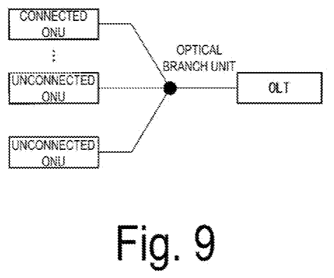

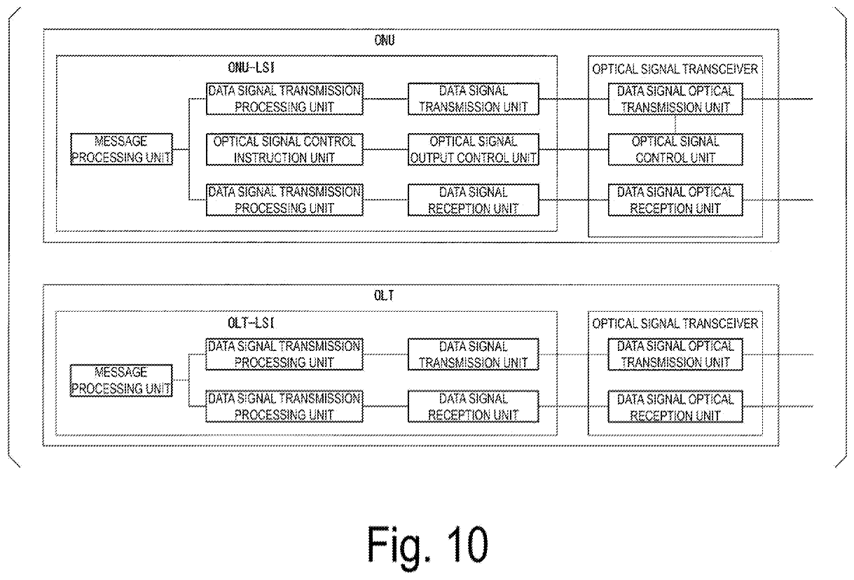

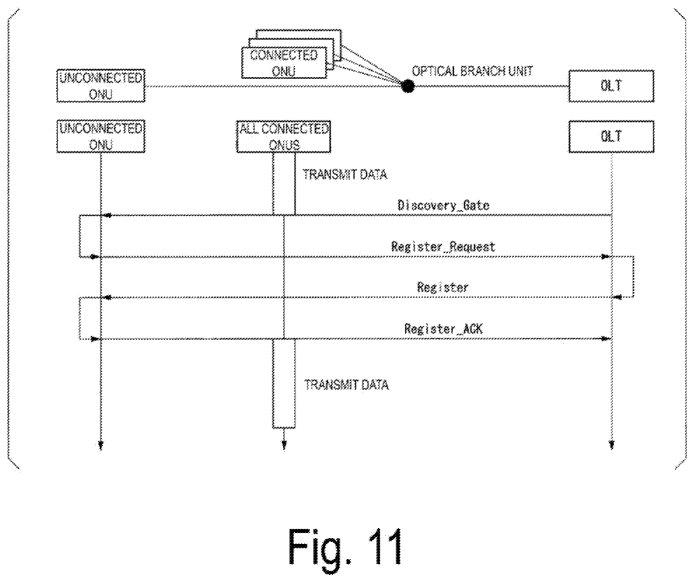

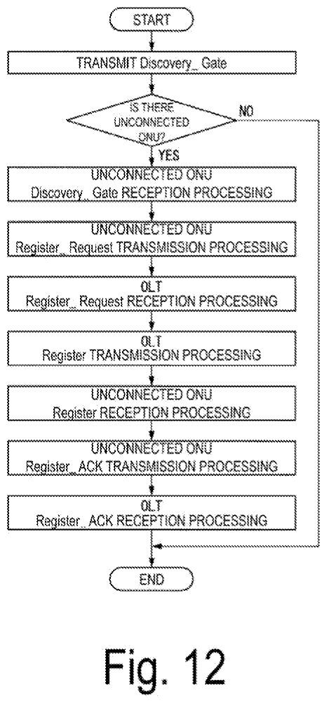

Next, initial connection processing A illustrated in FIG. 7 is executed (ACT003).

The OLT 20 transmits the initial connection start notification message to the unconnected ONU 10 (ACT101).

The unconnected ONU 10 receives the initial connection start notification message transmitted from OLT 20 (ACT102).

The description will be given by referring back to FIG. 6.

The unconnected ONU 10 transmits the idle signal to the OLT 20 (ACT004).
The OLT 20 detects the link failure and transmits the link failure notification to all the connected ONUs 10 (ACT005).
All the connected ONUs 10 suspend output of the optical signal (ACT006).
If there are two or more unconnected ONUs 10 (Yes in ACT007), the ONUs 10 wait until the respective random (appropriate) time periods elapse (ACT008). If the number of unconnected ONU 10 is less than two (if there is one unconnected ONU 10) (No in ACT007), the ONU 10 does not wait for the elapse of random (appropriate) time period as described above.
Then, initial connection processing B illustrated in FIG. 8 is repeated by the number of unconnected ONUs 10 (ACT017).

The unconnected ONU 10 transmits the initial connection response message to the OLT 20 (ACT201).

The OLT 20 receives the initial connection response message from the unconnected ONU 10 (ACT202).
The OLT 20 transmits the initial connection completion notification message to the unconnected ONU 10 (ACT203).
The unconnected ONU 10 receives the initial connection completion notification message transmitted from the OLT 20 (ACT204).
The description will be given by referring back to FIG. 6.
If the number of connected ONU 10 is less than one (if there is no connected ONU 10) (Yes in ACT001), the unconnected ONU 10 enters initial connection start standby without outputting the optical signal (ACT009).
The unconnected ONU 10 transmits the idle signal to the OLT 20 (ACT010).
If the number of unconnected ONU 10 is less than two (if the number of unconnected ONU 10 is one) (No in ACT011), the processing proceeds to ACT016 described below. If the number of unconnected ONUs 10 is two or more (Yes in ACT011), the OLT 20 detects the link failure and transmits the link failure notification to all the connected ONUs 10 (ACT012).

All the unconnected ONUs 10 suspend output of the optical signal (ACT013).

The ONU 10 waits until the random (appropriate) time period elapses (ACT014).
One of the unconnected ONUs 10 transmits the idle signal to the OLT 20 (ACY015).
Then, the initial connection processing A described above with reference to FIG. 7 is executed (ACT016).
Then, the initial connection processing B described above with reference to FIG. 8 is repeated by the number of unconnected ONUs 10 (ACT017).
Then, the processing in the flowcharts illustrated in FIGS. 6 to 8 ends.

As described above, when an Ethernet (registered trademark) device (ONU) is newly connected to the PON system, the control for preventing the optical signal transmission until the initial connection starts after the network connection is required to prevent collision between an optical signal transmitted by the ONU and an optical signal transmitted by another ONU. Furthermore, the initial connection needs to be enabled even when the link failure notification function is activated.

In the present disclosure, control is performed so that the ONU 10 including an Ethernet (registered trademark) device refrains from transmitting the optical signal when it is connected to the OLT 20, and control is performed so that the connected ONU 10 suspends output of the optical signal upon receiving the link failure notification. Thus, the present disclosure enables the initial connection to be performed with standard Ethernet (registered trademark) devices alone, in a configuration in which a plurality of network devices are connected to each other by the PON topology.

The embodiments of the present disclosure have been described above in detail with reference to the drawings. However, specific configurations are not limited to those embodiments, and include any design or the like within the scope not departing from the gist of the present disclosure.

Note that a part or all of the ONU 10 and the OLT 20 according to the embodiments described above may be realized by a computer. In that case, this configuration may be enabled by recording a program for implementing such control functions on a computer-readable recording medium and causing a computer system to read the program recorded on the recording medium for execution.

Note that it is assumed that the “computer system” mentioned here refers to a computer system built into the ONU 10 and the OLT 20, and the computer system includes an OS and hardware components such as a peripheral apparatus. The “computer-readable recording medium” refers to a portable medium such as a flexible disk, a magneto-optical disk, a ROM, and a CD-ROM, and a storage apparatus such as a hard disk installed in a computer system.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a certain period of time, such as a volatile memory within the computer system for functioning as a server or a client in such a case. Furthermore, the program may be configured to realize some of the functions described above, and also may be configured to be capable of implementing the functions described above in combination with a program already recorded in the computer system.

A part or all of the ONU 10 and the OLT 20 in the embodiments described above may be realized as an integrated circuit such as a Large Scale Integration (LSI). Each function block of the ONU 10 and the OLT 20 may be individually realized as processors, or a part or all thereof may be integrated into processors. Furthermore, a circuit integration technique is not limited to the LSI, and a part of or all of the transfer apparatus may be enabled with a dedicated circuit or a general-purpose processor. In a case that with advances in semiconductor technology, a circuit integration technology with which an LSI is replaced appears, an integrated circuit based on the technology may be used.

### REFERENCE SIGNS LIST

1 Communication system
10 Optical network unit (ONU)
11 Arithmetic processing unit
13 Ethernet controller
15 Optical signal transceiver
20 Optical line terminal (OLT)
21 Arithmetic processing unit
23 Ethernet controller
25 Optical signal transceiver
111 Message processing unit
112 Data signal transmission processing unit
113 Optical signal control instruction unit
114 Data signal reception processing unit
115 Initial connection start standby instruction unit
116 Initial connection start processing unit
117 Idle signal retransmission instruction unit
118 Initial connection response standby processing adding unit
119 Link failure processing unit
120 Initial connection response standby processing unit
131 Data signal transmission unit
132 Optical signal output control unit
133 Data signal reception unit
134 Link failure detection unit
151 Data signal optical transmission unit
152 Optical signal control unit
153 Data signal optical reception unit
211 Message processing unit
212 Data signal transmission processing unit
213 Data signal reception processing unit
214 Idle signal processing unit
231 Data signal transmission unit
232 Data signal reception unit
233 Link failure detection unit
251 Data signal optical transmission unit
252 Data signal optical reception unit

1. (canceled)

2. A communication device comprising a first communication device and a plurality of second communication devices in an optical access system in which the first communication device and the plurality of second communication devices communicate through a time division multiple access scheme, the second communication device comprising:
an Ethernet (registered trademark) controller configured to implement a communication as an Ethernet communication; and
a first suspension instruction unit configured to output, when the plurality of second communication devices perform an initial connection to a network in the optical access system, a first suspension instruction for causing suspension of an output of an optical signal to the first communication device for a predetermined time period.

3. The communication device according to claim 2 further comprising a first transmission instruction unit configured to output, when an initial connection start notification for causing initiation of a processing of the initial connection transmitted by the first communication device is not received over the predetermined time period after connected to the network, a first transmission instruction for causing transmission of an idle signal to the first communication device.

4. The communication device according to claim 3 further comprising a retransmission instruction unit configured to output, when a link failure occurrence notification indicating an occurrence of a link failure that is transmitted by the first communication device in response to the transmission of the idle signal to the first communication device is received, a retransmission instruction for causing suspension of an output of the optical signal to the first communication device and retransmit the idle signal after an optional amount of time period elapses.

5. The communication device according to claim 2 further comprising a second suspension instruction unit configured to output, when a link failure occurrence notification indicating an occurrence of a link failure is received after an initial connection start notification for causing initiation of a processing of the initial connection is received while the communication device has been connected to the network, a second suspension instruction for causing suspension of an output of the optical signal to the first communication device.

6. The communication device according to claim 2 or 5 further comprising a second transmission instruction unit configured to, when a link failure occurrence notification indicating an occurrence of a link failure is received while the communication device has been connected to the network, transmit a second transmission instruction for causing suspension of an output of the optical signal to the first communication device, and when the link failure occurrence notification is received while the communication device has not been connected to the network, transmit after elapse of an optional amount of time period an initial connection response to the first communication device that is a response to the first communication device for an initial connection start notification for causing initiation of a processing of the initial connection.

7. (canceled)

8. A communication method in an optical access system in which a first communication device and a plurality of second communication devices communicate through a time division multiple access method, the communication method performed by a computer of the plurality of second communication devices and comprising:
implementing a communication as an Ethernet (registered trademark) communication; and
outputting, when the plurality of second communication devices perform an initial connection to a network in the optical access system, a suspension instruction for causing suspension of an output of an optical signal to the first communication device for a predetermined time period.
